(19) United States
(12) Patent Application Publication
(10) Pub. No.: US 2026/0192372 A1
(43) Pub. Date: Jul. 9, 2026

(54) SAWING MACHINE WITH ADJUSTABLE ANGLE

(71) Applicant: DURQ MACHINERY CORP., Taichung City (TW)

(72) Inventors: Chia-Sheng LIU, Taichung City (TW); Chieh-Yuan TSAI, Taichung City (TW); Shih-Hui LINE, Taichung City (TW)

(21) Appl. No.: 19/064,156

(22) Filed: Feb. 26, 2025

(30) Foreign Application Priority Data
Jan. 3, 2025 (TW) 114100298

(51) Int. Cl. B23D 45/04; B23D 47/02; B27G 19/02

(52) U.S. Cl. CPC B23D 45/044; B23D 47/02; B27G 19/025

(57) ABSTRACT

A sawing machine includes a machine body, a linkage mechanism, and a lock mechanism. The machine body has a workbench, a machining module, and an arm pivotally connected to the workbench and the machining module. The linkage mechanism is pivotally connected to the machine body and has a first link, a second link pivotally connected to the first link, a third link pivotally connected to the second link, and a fourth link pivotally connected to the third link. The lock mechanism is attached to the arm of the machine body for restricting a position of the arm of the machine body. Thus, the linkage mechanism can adjust the angle of the machining module in correspondence with the position of the arm of the machine body, allowing the machining module to saw a workpiece at the correct cutting position.

### BACKGROUND OF THE INVENTION

### 1. Field of the Invention

The present invention relates to sawing machines and more particularly, to a sawing machine that can adjust its cutting angle.

### 2. Description of the Related Art

The sawing machine is a widely used product among power tools. Depending on the speed and type of the saw blade, it can be used to cut materials such as stone, tiles, wood, or metal. Currently, there are also portable handheld circular saws or cutting machines, which make it convenient for users to perform cutting tasks directly on materials at the processing site. When cutting metal materials with a cutting machine, in addition to selecting the appropriate saw blade based on the material thickness, it is even more important to cut from the correct position. It is generally recommended to start cutting from the edge of the workpiece, minimizing the contact area between the saw blade and the workpiece as much as possible. This helps facilitate the feeding process.

Due to various shapes and sizes of workpieces, it is necessary to adjust the machining head of the saw machine, so that the cutting position of the saw blade can align with the edge of the workpiece. CN 2822845 Y discloses that a circular saw machine includes a base, a swing arm, a saw blade, a protective cover, and a link. The sliding table of the base can be moved along the sliding axis, and the swing arm can drive the link to pivot downward. The link uses the push portion and the second section of the support portion as a pivot, thereby pulling the protective cover to rotate relative to the swing arm. The positioning portion of the sliding table is moved along the guide groove, allowing the protective cover to be lifted. CN 210387782 U discloses that a structure comprises a workbench, a machine head, a slide rail bracket, and a slide rail. The slide rail can be moved along the slide rail bracket to adjust the position of the machine head. This mechanism can change the cutting height and width of the machine head to accommodate cutting workpieces of different sizes.

However, in the aforesaid prior art, when adjusting the position of the sliding table or machine head to the rear, the sliding axis or slide rail protrudes beyond the back of the entire machine. This indicates that such a mechanism design requires a larger operating space and cannot be used against a wall. Additionally, when the position of the sliding table or machine head is at the front, the weight of the entire sawing module is concentrated at the front, causing the center of gravity of the machine to shift forward, which leads to instability and increased vibration during the cutting operation.

Therefore, the present invention provides a sawing machine with an adjustable cutting position that does not require excessive operating space, making the sawing machine more suitable for use in processing environments.

### SUMMARY OF THE INVENTION

It is one objective of the present invention to provide a sawing machine, which can make fine adjustments to allow for finding an optimal cutting position when sawing workpieces of various sizes and shapes, thereby achieving a purpose of easier and more efficient cutting.

To attain the above objective, the sawing machine of the present invention comprises a machine body, a linkage mechanism, and a lock mechanism. The machine body has a workbench, a machining module, and an arm pivotally connected to the workbench and the machining module. The linkage mechanism is pivotally connected to the machine body for adjusting an angle of the machining module in correspondence with a position of the arm of the machine body. The linkage mechanism has a first link, a second link pivotally connected to the first link, a third link pivotally connected to the second link, and a fourth link pivotally connected to the third link. The lock mechanism is attached to the arm of the machine body for restricting the position of the arm of the machine body.

It can be seen from the above that when adjustments to the position and angle of the machining module are needed, the user can unlock the lock mechanism from the arm to allow for adjustment. The arm provides a wide range of adjustment, while the linkage mechanism performs finer adjustments. This allows the machining module to achieve multi-angle adjustments. Additionally, the linkage mechanism does not require excessive workspace due to its small size, enabling changes to the position and angle of the machining module without taking up too much space. Once the machining module has been adjusted, the lock mechanism can be used to lock the arm in place. The linkage mechanism also remains in the adjusted position, preventing any shifts in the position of the machining module during sawing operations.

Preferably, the machining module includes a housing, a motor installed in the housing, a saw blade connected to the motor, a saw blade guard attached to the housing, and a handle fixed to the housing. In this way, the saw blade is driven by the motor to rotate and operated by the user holding the handle to perform cutting operation.

Preferably, one end of the arm is pivotally connected with the workbench through a lower shaft, and the other end of the arm is pivotally connected with the machining module and the second link of the linkage mechanism through an upper shaft. In this way, the arm drives the machining module to move forward and backward through the lower shaft and drives the machining module to move downward relative to the arm through the upper shaft for performing sawing operation.

Preferably, one end of the first link has a first guide groove, and the other end of the first link is pivotally connected with the second link. The first link is connected with the machining module through a pin inserted in the first guide groove. In this way, the first link drives the machining module to allow the machining module to make fine adjustments to its angle through the motion of the linkage mechanism.

Preferably, one end of the second link has a second guide groove, and the other end of the second link is pivotally connected with the first link. The second link is connected with the machining module through a pin inserted in the second guide groove, and further, one end of the arm is pivotally connected between the two ends of the machining body. In this way, when the arm is moved, the second link drives the other links to move together. When the arm is locked by the lock mechanism, the linkage mechanism cannot be moved to fix the angle of the machining module. When the sawing operation is performed by the machining module, the second guide groove can limit the downward movement of the machining module.

Preferably, one end of the third link is pivotally connected between the two ends of the second link, and the other end of the third link is pivotally connected to the fourth link. In this way, the third link acts as a parallel plate, and the third link is parallel to the arm and is moved with the forward and backward movement of the arm. This movement drives the other links to perform multi-angle adjustments.

Preferably, one end of the fourth link is pivotally connected to the third link, and the other end of the fourth link is pivotally connected to the workbench. In this way, the third link can be pivoted relative to the fourth link. One end of the linkage mechanism is fixed to the workbench. This not only securely fixes the linkage mechanism, but also allows the other end of the linkage mechanism to drive the machining module, making it easy to adjust the machining module to a desired position.

Preferably, the lock mechanism includes a fixed plate having one end fixed to the workbench and the other end provided with a positioning slot, and a positioning member inserted into the positioning slot and fixed to the arm of the machining body, so that the arm is movable along the positioning slot through the positioning member. In this way, the positioning member and the arm are in a linked state. When the positioning member is fixed, the arm will also be fixed and unable to move.

Preferably, the fixed plate further has a plurality of positioning holes communicating with the positioning slot, and the positioning member includes a positioning button inserted into the positioning slot and secured to the arm, a spring disposed on the positioning button, and a positioning ring sleeved on the positioning button and the spring and separately engaged with one of the positioning holes. In this way, the user can pull the positioning ring outward to release the lock mechanism that locks the arm, allowing the arm to be in a movable state. When the positioning ring is moved to another positioning hole, the positioning ring is pushed by the spring to lock into the positioning slot.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is a perspective view of a sawing machine of the present invention.

FIG. 2 is another perspective view of the sawing machine of the present invention from different angles.

FIG. 3 is an exploded view of the sawing machine of the present invention.

FIG. 4 is an exploded view of a saw blade guard provided by the sawing machine of the present invention.

FIG. 5 is an exploded view of a linkage mechanism provided by the sawing machine of the present invention.

FIG. 6 is an exploded view of a lock mechanism provided by the sawing machine of the present invention.

FIG. 7 is a right-side view of the sawing machine of the present invention, showing that the machining module is located at the second position.

FIG. 8 is a left-side view of the sawing machine of the present invention, showing that the machining module is located at the second position.

FIG. 9 is similar to FIG. 7, showing that machining module is located at the third position.

FIG. 10 is similar to FIG. 8, showing that machining module is located at the third position.

FIG. 11 is a right-side view of the sawing machine of the present invention, showing that the saw blade guard is lifted.

FIG. 12 is an enlarged view of the machining module provided by the sawing machine of the present invention, showing that the spindle screw is covered by the covering member.

FIG. 13 is an enlarged view of the sawing machine of the present invention, showing that the positional relationship between the covering element and the movable guard.

FIG. 14 is a lateral view of the sawing machine of the present invention, showing that the positional relationship of each element when the saw blade is replaced.

### DETAILED DESCRIPTION OF THE INVENTION

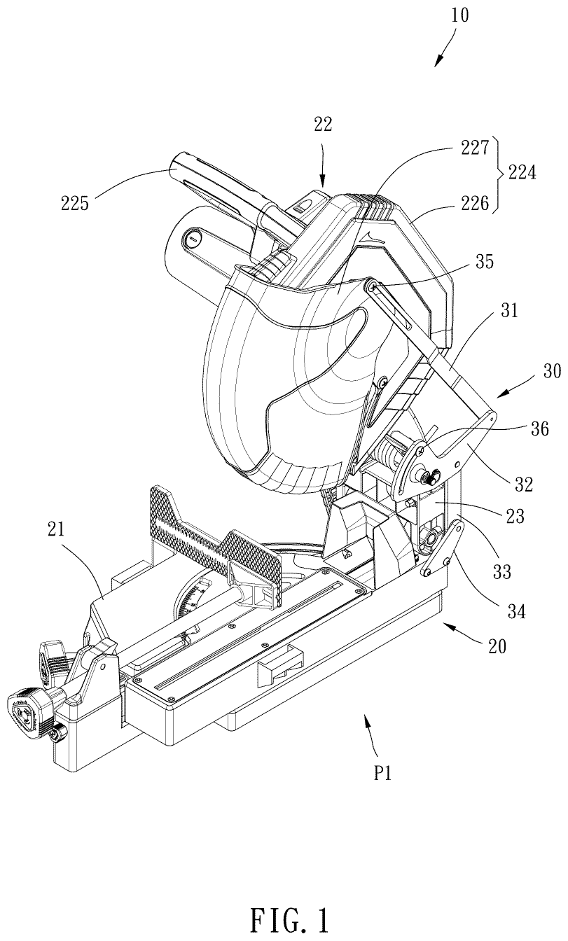

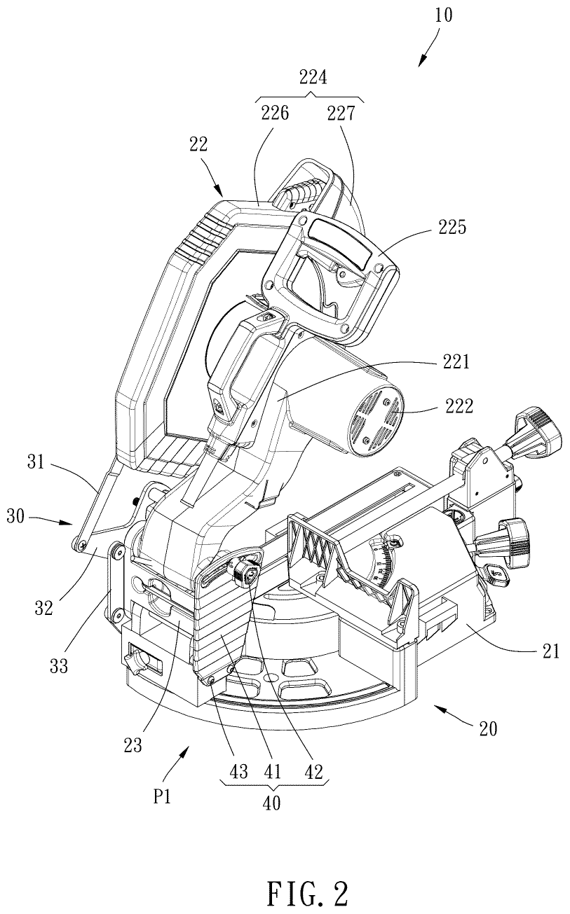

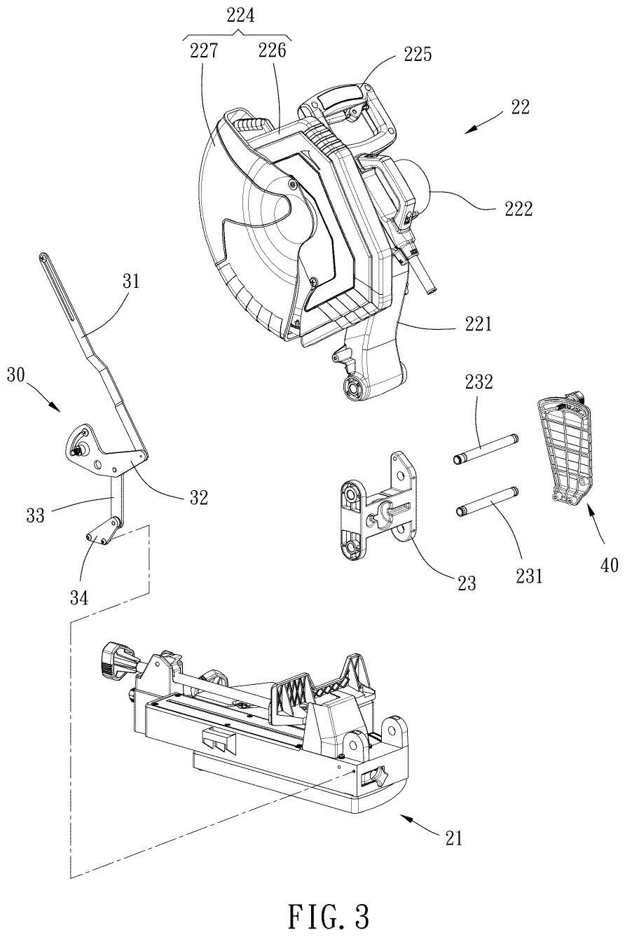

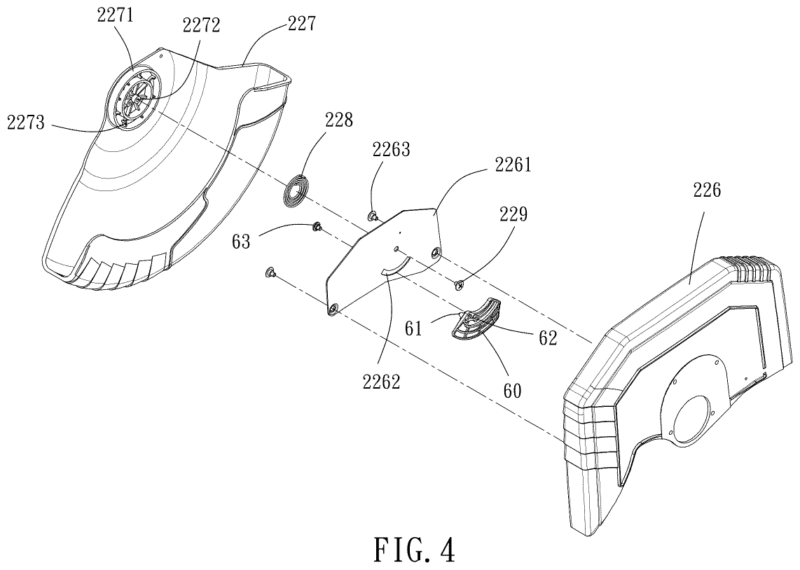

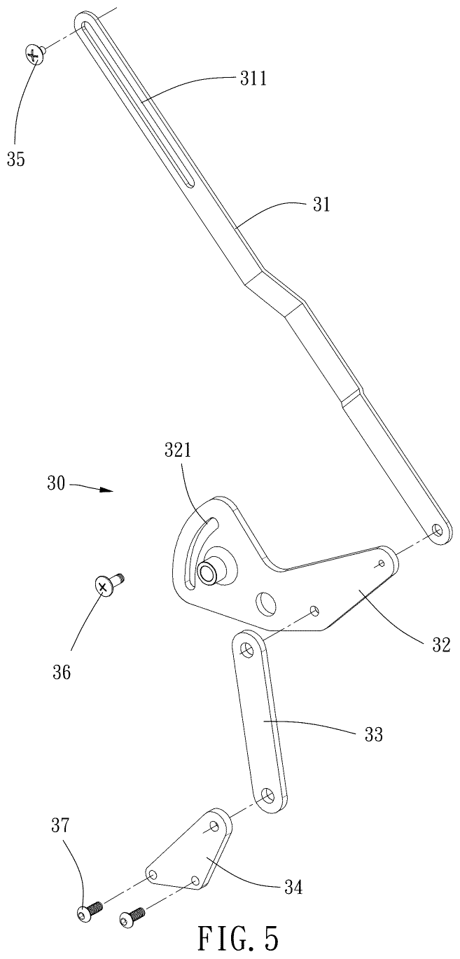

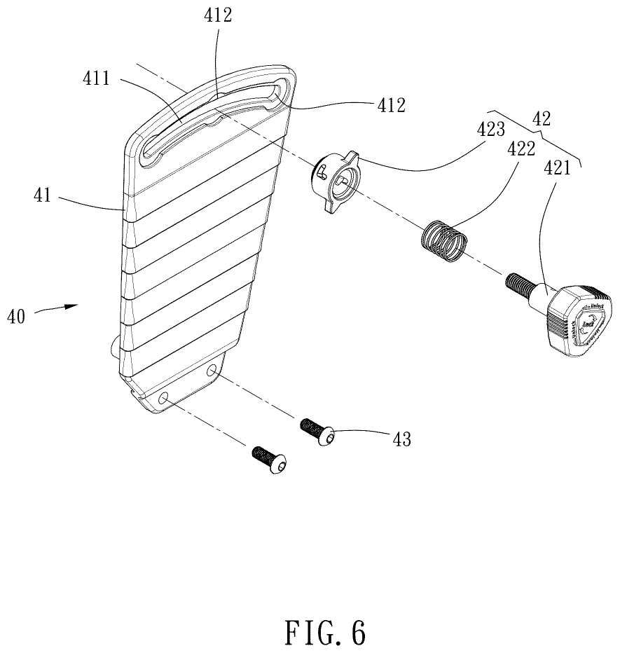

Referring to FIGS. 1 to 6, a sawing machine 10 of the present invention comprises a machine body 20, a linkage mechanism 30, and a lock mechanism 40.

The machine body 20 includes a workbench 21, a machining module 22, and an arm 23. The machining module 22 has a housing 221, a motor 222 installed in the housing 221, a saw blade 223 connected to the motor 222 through a spindle screw 2221, a saw blade guard 224 attached to the housing 221, and a handle 225 fixed to the housing 221. The arm 23 has an H-shaped structural appearance. The bottom end of the arm 23 is pivotally connected with workbench 21 through a lower shaft 231, and the top end of the arm 23 is pivotally connected with the machining module 22 through an upper shaft 232.

The saw blade guard 224 includes a fixed guard 226 fixed to the housing 221, a connecting plate 2261 fixed to the fixed guard 226 through two pins 2263, and a third guide groove 2262 formed on the connecting plate 2261. Additionally, the saw blade guard 224 further includes a movable guard 227 and an elastic member 228. The inner surface of the movable guard 227 has a connecting portion 2271, a connecting hole 2272 provided at the center of the connecting portion 2271, and at least one push portion 2273 formed on the connecting portion 2271. The movable guard 227 is pivotally connected with the connecting plate 2261 through a pin 229 inserted in the connecting hole 2272. Two ends of the elastic member 33 are attached to the connecting plate 311 and the connecting portion 321 of the movable guard 32, respectively. When the sawing operation is not performed, the saw blade 223 is covered by the fixed guard 226 and the movable guard 227 for preventing accidental contact by a user. When the sawing operation is performed, the machining module 22 is moved downward relative to the arm 23. At this point, the movable guard 227 is pivoted upward through the tension of the elastic member 228, while the fixed guard 226 remains stationary.

The linkage mechanism 30 is pivotally connected to one side of the machine body 20. The linkage mechanism 30 includes a first link 31, a second link 32, a third link 33, and a fourth link 34. One end of the first link 31 has an elongated first guide groove 311. The first link 31 is connected with the movable guard 227 through a pin 35 inserted in the first guide groove 311. The other end of the first link 31 is pivotally connected with the second link 32. The second link 32 has an arc-shaped second guide groove 321, and the second link 32 is connected with the housing 221 of the machining module 22 through a pin 36 inserted in the second guide groove 321. One end of the arm 23 is pivotally connected between two ends of the second link 32 through the upper shaft 232. The third link 33 is parallel to the arm 23. One end of the third link 33 is pivotally connected between the two ends of the second link 32, with this connection location adjacent to the connection point between the second link 32 and the arm 23. The other end of the third link 33 is pivotally connected to one end of the fourth link 34. The other end of the fourth link 34 is fixed to the workbench 21 by using screws 37.

The relative positions of the arm 23, the second link 32, the third link 33, and the fourth link 34 form a quadrilateral shape. Through the motion of the linkage mechanism 30, multiple angular position combinations can be achieved, allowing the machining module 22 to be adjusted to multiple positions.

The lock mechanism 40 is attached to the arm 23 for limiting the position of the arm 23. The lock mechanism 40 includes a fixed plate 41 and a positioning member 42. The bottom end of the fixed plate 41 is secured to the workbench 21 by using screws 43. The top end of the fixed plate 41 has a positioning slot 411 and a plurality of positioning holes 412 communicating with the positioning slot 611. The positioning member 42 has a positioning button 421, a spring 422 disposed on the positioning button 421, and a positioning ring 423 sleeved on the positioning button 421 and the spring 422. The positioning button 421 is inserted into the positioning slot 411 and secured to the arm 23 of the machine body 20, so that the tapered front end of the positioning ring 423 can be engaged with one of the positioning holes 412. The position of the positioning member 42 is fixed within the positioning slot 411 to restrict the position of the arm 23 of the machine body 20. When the positioning ring 423 is pulled, the front end of the positioning ring 423 is disengaged from the positioning hole 412, allowing the arm 23 to be moved along the positioning slot 411 through the positioning member 42.

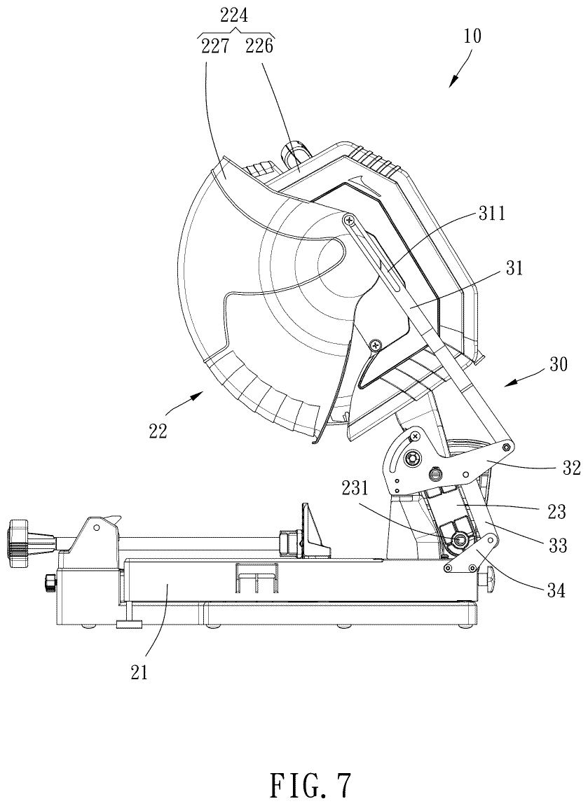

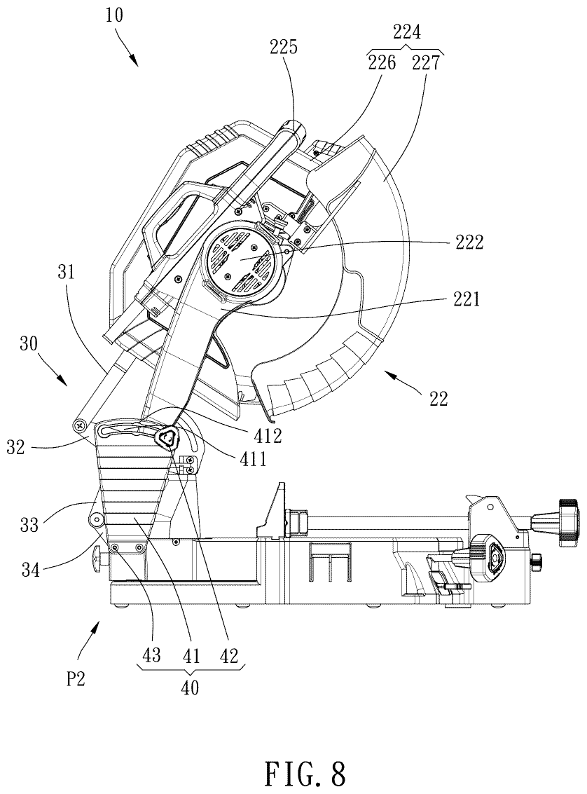

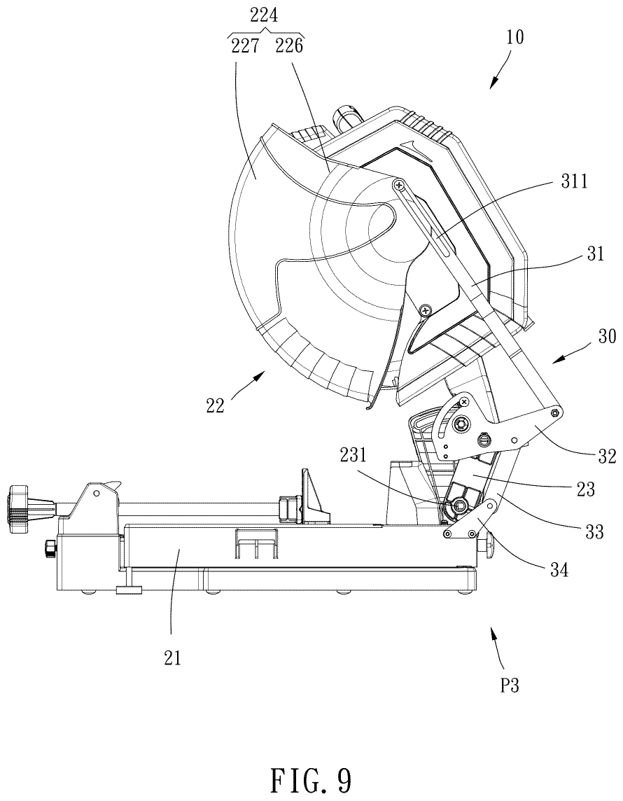

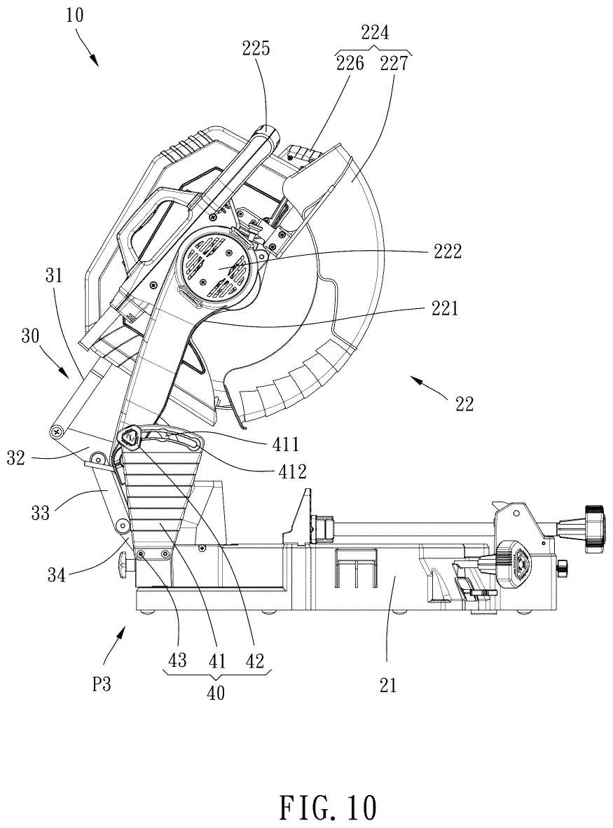

Please refer to FIGS. 1, 2, and 7 to 10, this embodiment provides three modes, showing the angles at which the machining module 22 is positioned when the lock mechanism 40 is in three locking positions.

When the lock mechanism 40 is located at a first position P1, the positioning member 42 is engaged with the positioning hole 412 located at the middle of the positioning slot 411, causing the arm 23 and the third link 33 to be perpendicular to the ground. This allows the machining module 22 to be slightly tilted forward.

When the lock mechanism 22 is adjusted from the first position P1 to a second position P2 or a third position P3, the user pulls the positioning ring 423 outward, causing the positioning ring 423 to disengage from the positioning hole 412 while simultaneously compressing the spring 422. At this point, the positioning member 42 can slide along the positioning slot 411, allowing the arm 23 and the linkage mechanism 30 to be in a movable state. This enables the user to grip the handle 225 to adjust the position of the machining module 22. As the position of the machining module 22 changes, the arm 23 be moved forward or backward along the positioning slot 411, simultaneously driving the linkage mechanism 30 to be moved. Since the second link 32 is pivoted relative to the arm 23, through the pivot movement of the second link 32 relative to the arm 23, the machining module 22 can also generate slight upward or downward movements, allowing the saw blade 223 to be fine-tuned to an appropriate position. After the adjustment, releasing the force on the positioning ring 423 allows the positioning ring 42 to be engaged with the corresponding positioning hole 412 at the second position P2 or the third position P3 by the restoring force of the spring 422, thereby fixing the position of the arm 23.

When the lock mechanism 40 is located at the second position P2, the positioning member 42 is engaged with the positioning hole 412 located at the front end of the positioning slot 411, causing the arm 23 and the third link 43 to be slightly tilted forward. Thus, the machining module 22 has a greater forward tilt compared to the first position P1. As a result, the position of the saw blade 223 is farther forward, making the cutting position more distant from the arm 23.

When the lock mechanism 40 is located at the third position P3, the positioning member 42 is engaged with the positioning hole 412 located at the rear end of the positioning slot 411, causing the arm 23 and the third link 43 to be tilted backward. Thus, the machining module 22 has a greater backward tilt compared to the first position P1. As a result, the position of the saw blade 223 is farther backward, making the cutting position closer to the arm 23.

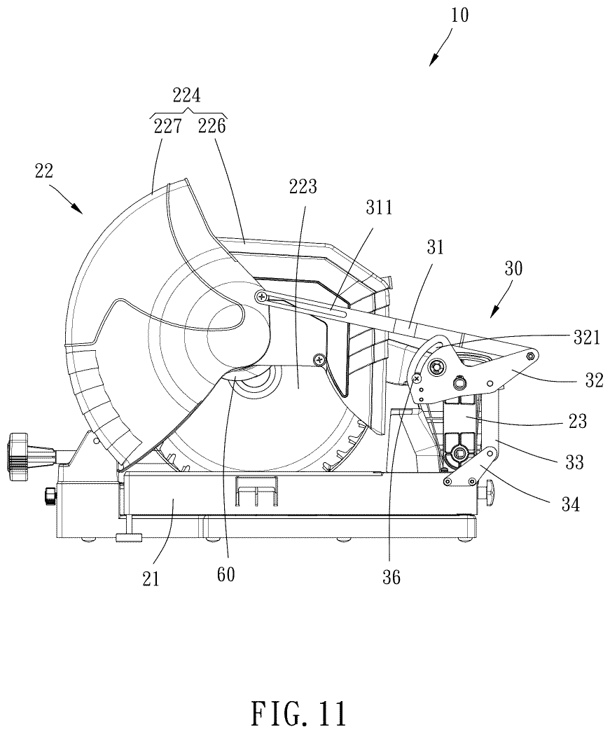

As shown in FIG. 11, when a workpiece is placed on the workbench 21 and securely clamped, the user first adjusts the position and angle of the machining module 22 according to the edge of the workpiece. Then, the motor 222 is activated to drive the saw blade 223 to rotate. At this point, the user grips the handle 225 and applies downward force. The first link 31 of the linkage mechanism 30 is driven to pivot downward. The arm 23 is restricted in position by the positioning member 42, so the machining module 22 is pivoted around the upper shaft 232, while the arm 23 remains stationary. The machining module 22 is pivoted downward along the second guide groove 321, allowing the machining module 22 to follow a designed path for the sawing operation. This makes precise cuts to the workpiece. During the downward movement of the machining module 22, the elastic member 228 automatically causes the movable guard 227 to pivot upwards. Therefore, the saw blade 223 will only be exposed to contact the workpiece when it approaches the workpiece.

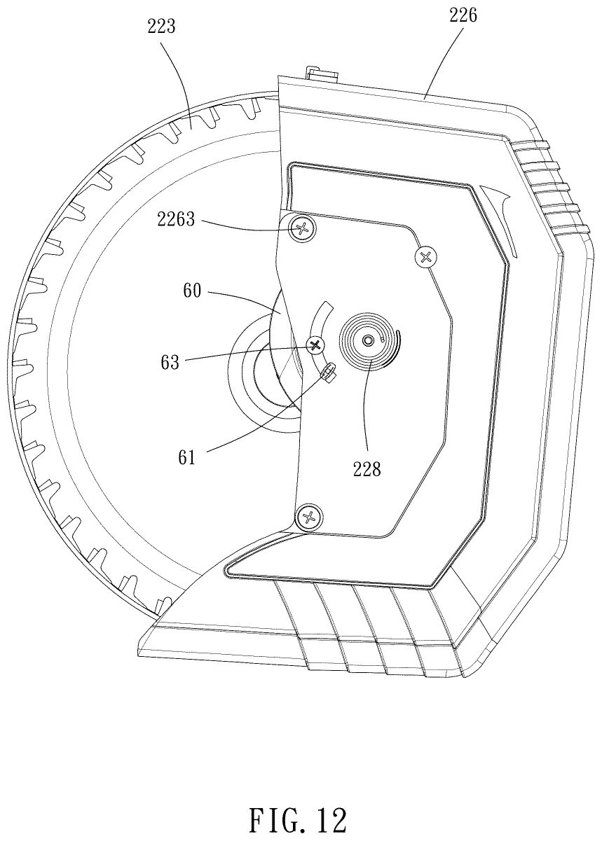

Additionally, the present invention further illustrates the procedure for replacing the saw blade 223. As shown in FIGS. 12-14, the sawing machine 10 further comprises a covering element 60 that is used to cover the spindle screw 2221 that is fixed to the saw blade 223, preventing the spindle screw 2221 from being disassembled arbitrarily. FIG. 12 shows the covering element 60 while omitting the movable guard 227.

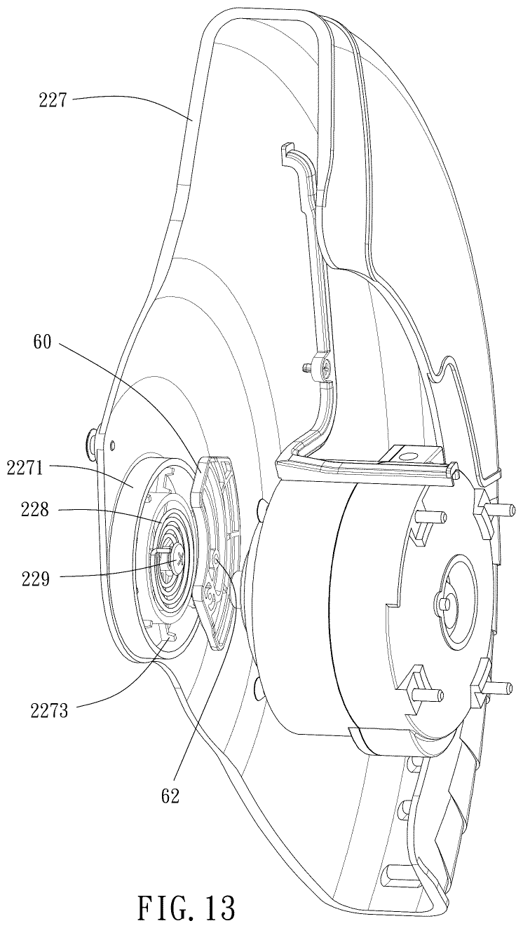

The covering element 60 has a protrusion 61 and a linking hole 62 passing through two opposite sides of the covering element 60. The protrusion 61 is inserted in the third guide groove 2262 of the fixed guard 226 and abutted against the push portion 2273 of the movable guard 227. A pin 63 is inserted in the third guide groove 2262 of the fixed guard 226 and the linking hole 62 of the covering element 60. FIG. 13 omits the fixed guard 226 in order to clearly show the relative relationship between the covering element 60 and the movable guard 227.

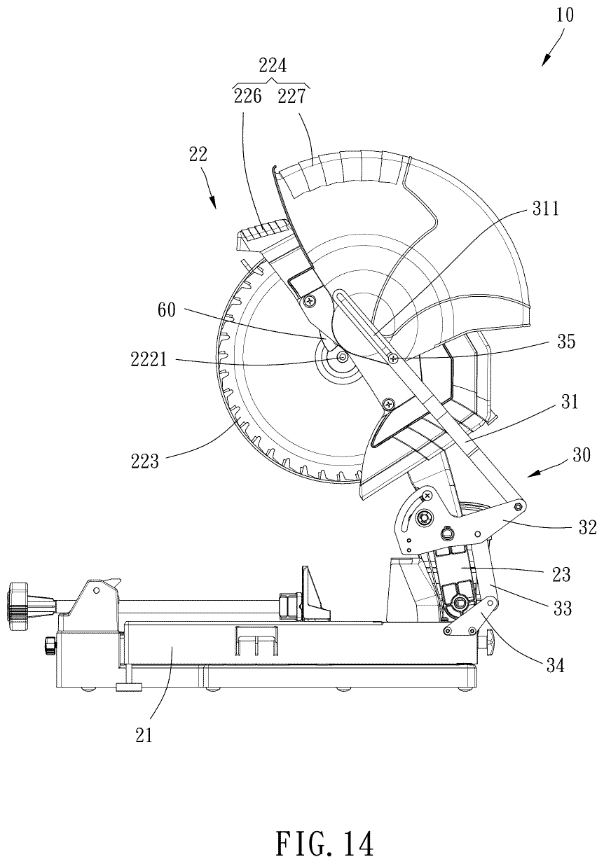

When replacing the saw blade 223, the user manually lifts the movable guard 227 to a certain position, and then applies force to lift the movable guard 227 upward. As the movable guard 32 is moved backward, the pin 35 travels from the top end of the first guide groove 311 to the bottom end of the first guide groove 311. At this point, the protrusion 61 of the covering element 60 is pushed by the push portion 2273 of the movable guard 227. The covering element 60 is then moved along the third guide groove 2262 through the pin 63 (as shown in FIG. 14), thereby exposing the spindle screw 2221. This allows the user to use a tool to remove the spindle screw 2221 and replace the saw blade 223.

Based on the above, the sawing machine 10 of the present invention, compared to the prior art, has at least the following advantages:
1. The sawing machine 10 of the prevent invention uses the configuration of the linkage mechanism 30 and the arm 23 to form multiple angle combinations. This allows the machining module 22 to be adjusted to multiple positions, thereby finding the most suitable cutting position for each workpiece and reducing the wear on the saw blade 223.
2. The sawing machine 10 of the present invention provides position adjustment and fixation for the machining module 22 through the lock mechanism 40. When the position and angle of the machining module 22 are determined, the lock mechanism 40 can restrict the position of the arm 23 of the machine body 20, preventing any displacement of the machining module 22 during the sawing operation. This ensures improved stability and precision.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A sawing machine comprising:
a machine body having a workbench, a machining module, and an arm pivotally connected to the workbench and the machining module;
a linkage mechanism pivotally connected to the machine body for adjusting an angle of the machining module in correspondence with a position of the arm of the machine body, the linkage mechanism having a first link, a second link pivotally connected to the first link, a third link pivotally connected to the second link, and a fourth link pivotally connected to the third link; and
a lock mechanism attached to the arm of the machine body for restricting the position of the arm of the machine body.

2. The sawing machine as claimed in claim 1, wherein the machining module includes a housing, a motor installed in the housing, a saw blade connected to the motor, a saw blade guard attached to the housing, and a handle fixed to the housing.

3. The sawing machine as claimed in claim 1, wherein one end of the arm is pivotally connected with the workbench through a lower shaft, and the other end of the arm is pivotally connected with the machining module and the second link of the linkage mechanism through an upper shaft.

4. The sawing machine as claimed in claim 1, wherein one end of the first link has a first guide groove, and the other end of the first link is pivotally connected with the second link; the first link is connected with the machining module through a pin inserted in the first guide groove.

5. The sawing machine as claimed in claim 1, wherein one end of the second link has a second guide groove, and the other end of the second link is pivotally connected with the first link; the second link is connected with the machining module through a pin inserted in the second guide groove; one end of the arm is pivotally connected between the two ends of the second link.

6. The sawing machine as claimed in claim 1, wherein one end of the third link is pivotally connected between the two ends of the second link, and the other end of the third link is pivotally connected to the fourth link.

7. The sawing machine as claimed in claim 1, wherein one end of the fourth link is pivotally connected to the third link, and the other end of the fourth link is pivotally connected to the workbench.

8. The sawing machine as claimed in claim 1, wherein the lock mechanism includes a fixed plate having one end fixed to the workbench and the other end provided with a positioning slot, and a positioning member inserted into the positioning slot and fixed to the arm of the machining body, so that the arm is movable along the positioning slot through the positioning member.

9. The sawing machine as claimed in claim 8, wherein the fixed plate further has a plurality of positioning holes communicating with the positioning slot, and the positioning member includes a positioning button inserted into the positioning slot and secured to the arm, a spring disposed on the positioning button, and a positioning ring sleeved on the positioning button and the spring and separately engaged with one of the positioning holes.
